(19) United States
(12) Patent Application Publication
(10) Pub. No.: US 2008/0095387 A1
(43) Pub. Date: Apr. 24, 2008

(54) Wirelessly programmable hearing aid device

(76) Inventors: Torsten Niederdrank, Erlangen (DE); Gottfried Ruckerl, Nurnberg (DE)

Correspondence Address: SCHIFF HARDEN LLP;Patent Department, 6600 Sears Tower, 233 South Wacker Drive, Chicago, IL, 60606, US

(21) Appl. No.: 10/636,790

(22) Filed: Aug. 7, 2003

(30) Foreign Application Priority Data
Aug. 8, 2002 (DE) 102 36 469.9

(51) Int. Cl. H04R 25/00

(52) U.S. Cl. 381/314; 381/315

(57) ABSTRACT

A hearing aid device that, for example, can be wirelessly programmed by an external transmission and/or receiving unit, includes a circuit chip in which is integrated with a coil in the form of a coil structure for the exchange of electromagnetic signals. The integration of the coil structure permits a greatly reduced space requirement for the coil structure which can be used as an antenna.

### FIELD OF THE INVENTION

The present invention concerns a hearing aid device with a circuit chip and with a coil for wireless transmission of electromagnetic signals between the hearing aid device and an external transmission and/or receiving unit.

### DESCRIPTION OF THE RELATED ART

A programmable hearing aid device enables the functions of the hearing aid device to be optimally adapted to the hearing loss of the user, and permits the hearing aid device to be used in the most varied of surroundings. The programming of the hearing aid device is preferably implemented while it is being worn. This requires the presence of a programmer interface in the hearing aid device that is easily accessible and further requires the use of a programmer device which has as small an influence on the acoustics during the programming of the hearing aid device as possible. Wirelessly programmable hearing aid devices that have such an interface for the most part rely upon a pair of transmission and/or receiving units in the hearing aid device and in the programmer device.

A wirelessly programmable electrical hearing aid is disclosed in European Published Patent Application EP 0 448 764 B1 in which transmission and/or receiving units are respectively located in the hearing aid device and in the programmer device. The transmission of the programmer signal ensues with electromagnetic signals that are generated with an antenna coil of the transmission and/or receiving unit of the programmer device and received with an antenna coil of the transmission and/or receiving unit of the hearing aid device. The response signals of the hearing aid device are transmitted in the same manner, only in the other direction. To optimize the bi-directional data transmission, the two coils should be arranged spatially relative to one another with a maximum permeation of the generated electromagnetic fields by the coils.

The difficulty is to spatially house the transmission and/or receiving unit in the hearing aid device, since the components of the transmission and/or receiving unit (for example, the antenna and battery) require considerable space.

In German Patent Document DE 195 41 648 A1, a mobile transmission and/or receiving module is provided that only contacts the hearing aid device if needed (i.e., for programming), in order to circumvent the shortage of space.

A hearing aid is known from U.S. Pat. No. 5,721,783 that comprises an earpiece and a remote processor unit (RPU). For example, the signal processing and signal amplification are implemented in the RPU. The earpiece comprises a transponder to receive the amplified signal of the RPU and transmit the amplified signal to the loudspeaker.

A wireless short-range communication system is known from European Patent Document EP 0706732 to transmit a tone frequency input signal. A transmission loop that is manufactured in thick-film technology is applied to a printed circuit board in the device.

### SUMMARY OF THE INVENTION

The present invention simplifies the assembly of a wirelessly programmable hearing aid device, and enables a more compact construction of the hearing aid.

This is achieved in a hearing aid device with a circuit chip and with a coil, for example an antenna coil, for wireless transmission of electromagnetic signals between the hearing aid device and an external transmission and/or receiving unit, wherein the coil is integrated into the chip in the form of a coil structure. The circuit chip can, for example, be comprised of a silicon substrate, in which and/or on which one or more semiconductor levels and/or interconnects are located. These semiconductor levels and/or interconnects are indicated in the following as coating levels on the chip.

The integrated coil structure has the advantage that is requires almost no additional space in the hearing aid device, and thus enables a very compact size for the hearing aid device. The use of a wireless transmission circuit realized in this manner thus avoids the disadvantages which are present in hearing aid devices according to the prior art, in that the prior art transmission and/or receiving units for wireless transmission generally take up a substantial area in the hearing aid devices.

### BRIEF DESCRIPTION OF THE DRAWINGS

FIG. 1 is a schematic overview corresponding to the prior art and to the present invention for programming a hearing aid device with a coil in the hearing aid device and a coil in the programmer device;

FIG. 2 is a side view, partially in phantom, of a hearing aid device, in which a coil structure is integrated into a circuit board in the form of a spiral;

FIG. 3 is a perspective view, partially in phantom, of an embodiment of a chip, in which the coil structure in the form of a spiral extends over a plurality of coating levels;

FIG. 4 is an enlarged perspective view showing an embodiment of a hearing aid device worn in the ear, with a transponder integrated into the chip;

FIG. 5 is a functional block diagram showing the operating mode of a transponder; and

FIG. 6 is a front view showing an exemplary embodiment, in which the electromagnetic fields received by the hearing aid device are generated by a telephone coil.

### DETAILED DESCRIPTION OF THE PREFERRED EMBODIMENTS

The present hearing aid device lacks the disadvantages inherent in the generally short range of the wireless exchanges using an integrated coil structure since the coil of the external transmission and/or receiving unit can be applied closer to the hearing aid device. The integrated coil structure is also advantageous for the production process, since is allows a simpler assembly.

The programming of a hearing aid device according to the present invention with the delivery parameters is simplified and accelerated, since, in comparison to a mobile transmission and/or receiving module according to the German Patent Document DE 195 41 648 A1, the creation of a connection with the hearing aid device is omitted. In addition, the protection from damage by external influences is improved.

The areas of application of a wireless transmission circuit realized according to the invention lie in the already mentioned programming and transmission of control data, as well as in the transmission of original or compressed audio data.

In an embodiment of the invention, the coil is an antenna of a transponder. The transponder circuit can also be integrated into the chip. For exmaple, the antenna of the transponder is implemented as the coil structure and both are integrated into the chip. A very compact transponder assembly is realized in this manner. The transponder serves to receive and transmit data on slightly shifted frequency bands.

Additionally, the transponder enables energy to be acquired from a radiated electromagnetic field.

In an embodiment, the hearing aid device comprises a programmable signal processing device, in which, for example, the hearing aid parameters are processed that conform the hearing aid device to the hearing loss of the user. Further parameters, such as an identification code or parameters for the various function modes of the hearing aid device, can be saved in the signal processing device.

A further preferred embodiment of the coil structure is connected with the programmable signal processing device of the hearing aid device, and thus forms a programmer interface that enables a wireless transmission of, for example, the parameters (as noted above) between the external transmission and/or receiving unit and the hearing aid device.

A further preferred embodiment of the external transmission and/or receiving unit comprises a coil made from an electrical conductor that is advantageously spatially arranged during the programming, such that the generated electromagnetic fields maximally permeate the coil structure of the hearing aid chip.

In an especially preferred embodiment, the external transmission and/or receiving unit is connected with a device for programming the signal processing device, with which, for example, a hearing aid acoustician can adjust the hearing aid device to the respective hearing loss of the user.

In a further preferred embodiment, the coil structure is fashioned for bi-directional transmission, i.e. as a transmission and/or receiving coil, such that signals of the external transmission and/or receiving unit can be received from the hearing aid device, and that response signals (that, for example, acknowledge a successful programming of the hearing aid device) can be sent back to the external transmission and/or receiving unit. The integrated coil structure can be implemented as part of a transponder system. This has the advantage that the coil structure can serve for contact-less energy acquisition from the ensuing electromagnetic fields. The external transmission and/or receiving unit thereby continually supplies the transponder system with energy via the electromagnetic field, according to the principle of inductive coupling. The energy can then be used for the programming of the signal processing device or for the transmission of response signals. The batter of the hearing aid is thus only slightly burdened during the programming.

This is also true for a particular embodiment of a hearing aid device, in which the transponder is integrated as a whole into the chip. Here as well, the energy supply can ensue from the external electromagnetic field according to the principle of inductive coupling.

In an embodiment of the invention, the coil structure in integrated into the circuit board or the chip in the form of a spiral. This has the advantage that the structure can be implemented in a single coating level on the chip.

In a further embodiment, the coil structure runs within a plurality of coating levels. This has the advantage that only very little space is required by the coil in the respective coating level.

In a further embodiment, the external transmission and/or receiving unit is part of a device to transmit acoustic signals, whereby electromagnetic fields are sent from the external transmission and/or receiving unit and received by the coil structure in the hearing aid device. This embodiment also has the advantage that the coil structure in the hearing aid device can serve as a receiving coil of electromagnetic fields that are emitted, for example, from loudspeaker coils, as perhaps from a telephone coil in the telephone handset.

The invention can be implemented in all known hearing aid device types, for example in hearing aid devices that are worn behind the ear, hearing aid devices that are worn in the ear, hearing aid device systems, or pocket hearing aid devices.

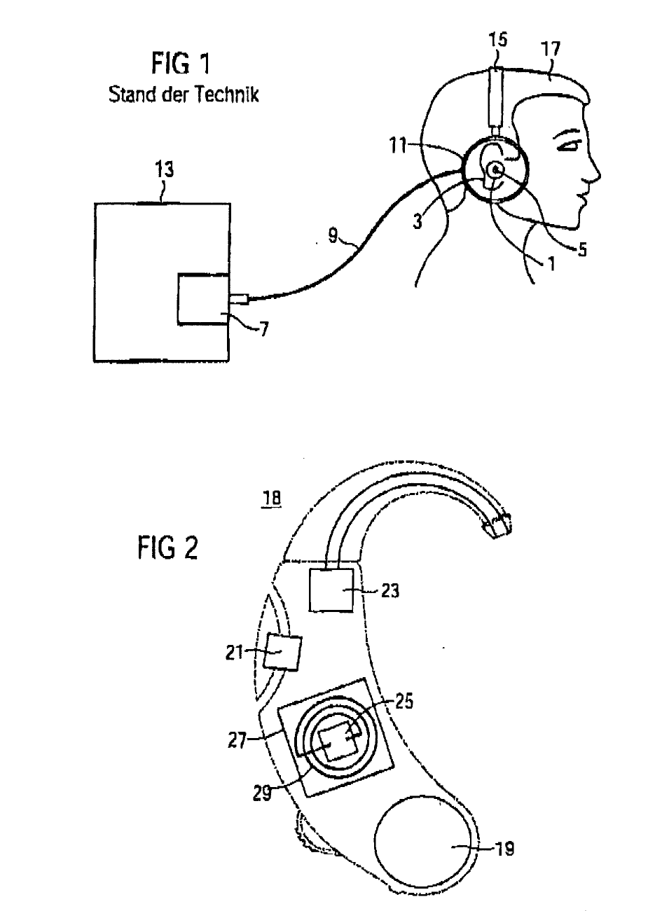

With reference to the drawings, FIG. 1 gives an overview for wireless programming of a hearing aid device 1. The person with hearing loss wears a hearing aid device 1 in the ear 3, the hearing aid having a coil 5. A transmission and/or receiving unit 7, connected via a conductor 9 with a programmer coil 11, is used to program the hearing aid device 1. The transmission and/or receiving unit 7 is part of a programmer device 13. The programmer coil 11 is attached to the head 17 of the hearing aid device wearer with the aid of a clip or headband 15. The programmer device 13 transmits a programmer signal to the programmer coil 11 that is transduced into an electromagnetic signal. The electromagnetic signal induces a voltage in the coil 5 of the hearing aid device 1 that is used for programming the hearing aid device 1. The programmer coil 11 has little influence on the acoustics of the surroundings a sensed by the hearing aid device 1 worn in the ear 3.

A first embodiment of an inventive hearing aid device 18 is shown in FIG. 2. It comprises a battery 19, a microphone arrangement 21, and a loudspeaker 23. The signals acquired with the microphone assembly 21 are processed (corresponding to the respective hearing loss of the user) with the aid of a signal processor 25 and transmitted via the loudspeaker 23 to the person with hearing loss. The signal processor 25 is located on a circuit board 27. A coil structure 29 in the form of a spiral is integrated into a coating level of the circuit board 27. The coil structure 29 receives an electromagnetic signal emitted from a programmer coil 11, inductively transduces it into an electronic signal, and then transmits this to the signal processor 25, that is, in turn, programmed by means of the electronic signal. Electronic response signals of the signal processor 25 to the programming device 13 are likewise transduced and transmitted to the programmer coil 11. The better part of the energy required for the programming is met by the energy acquired inductively by the coil structure 29, and only a small part of the necessary energy is taken from the hearing aid device battery 19.

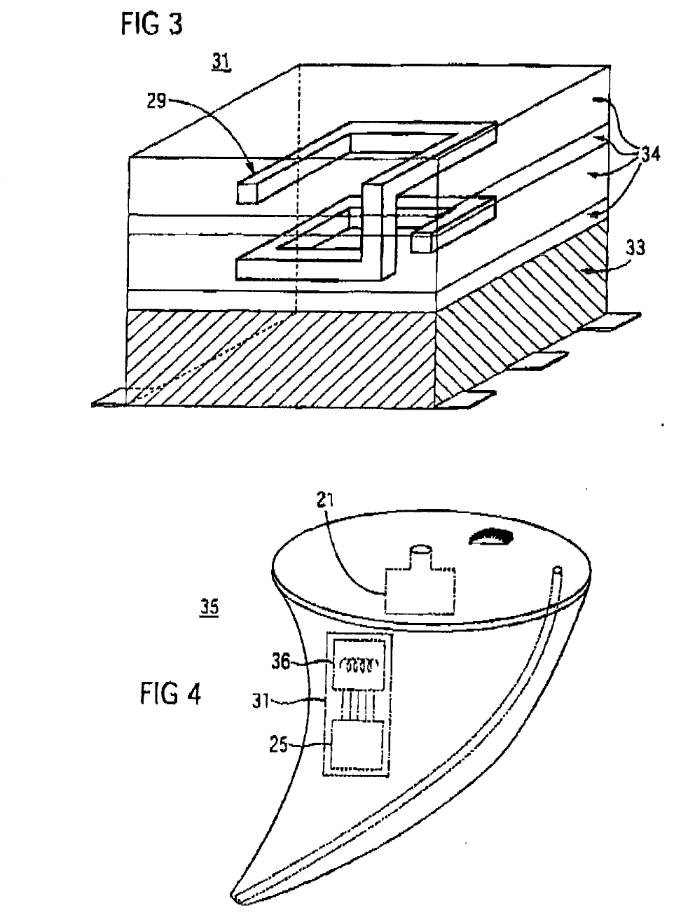

A circuit chip 31 of a hearing aid device according to the invention is shown in FIG. 3, with an integrated coil structure 29. Located on the chip substrate 33 are a plurality of coating levels 34, that are here shown greatly enlarged. The coil structure is three-dimensionally integrated into the coating level 34.

If the chip and the circuit board are combined as a component in the form of a hybrid, the coil structure can also be integrated into this hybrid. The integration is thereby possible in the chip or the circuit board of the hybrid. In such a hybrid, this can also be transferred to the integration of a transponder.

FIG. 4 shows an embodiment of a hearing aid device 35 worn in the ear, with a transponder 36 that is integrated into a chip 31 of the hearing aid device 35. Particularly for hearing aid devices 35 worn in the ear, the space available for use is extremely limited, such that here the advantages of the integration have an increased effect. In addition to a transponder 36, a signal processor 25 of the hearing aid device 35 is integrated into the same chip. No modification of the hearing aid device (for example, the connection of an auxiliary battery) is necessary for the programming, and the acoustics are not constrained during the programming. The functionality of the transponder 36 is specified in the following.

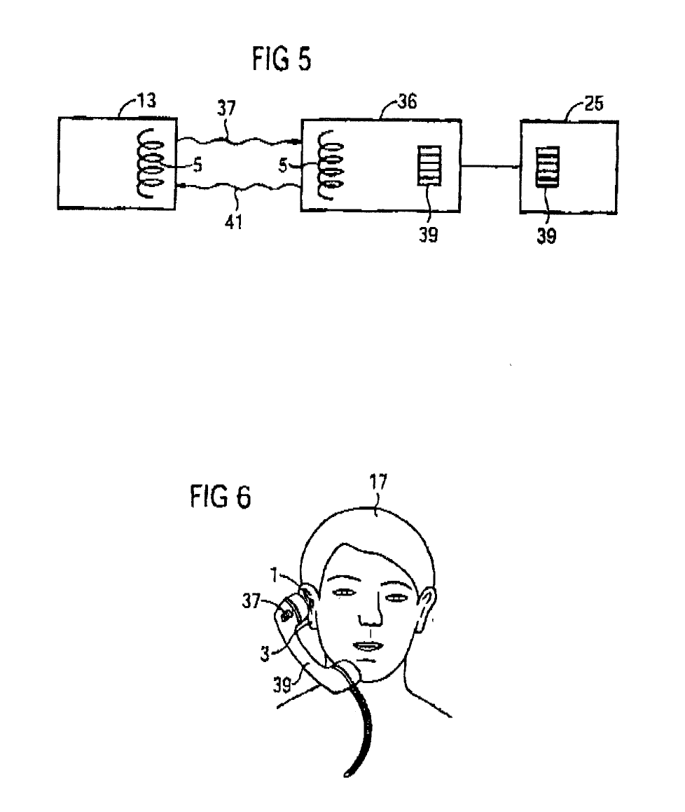

A block diagram of the mode of operation of the transponder 36 is shown in FIG. 5. A programmer signal 37 of a programmer device 13 (indicated in connection with transponder 36 as a read-write device) is wirelessly transmitted to the transponder 36 by means of magnetic or electromagnetic fields that are generated by a coil 5 in the programmer device 13. Programmer signals 37 affect a programming of one or more storage elements 39, that are incorporated directly into the transponder 36, or into the signal processor 25. One or more response signals 41 are sent back from transponder 36 to the programmer device 13. The energy necessary for the data exchange, the operation of the transponder 36, and to read and write from or to storage elements 39, are acquired from the ensuing alternating electromagnetic field that generates a voltage in the coil 5 of the transponder 36 which is used as a power supply, and makes an auxiliary battery for programming superfluous.

Shown in FIG. 6 is the use of the coil structure 29 in a hearing aid device 1 to receive electromagnetic signals that are emitted from a modified telephone coil 37 of a telephone handset 39. The transduction of electrical signals into acoustic signals ensues in the loudspeaker with the aid of the telephone coil 37. The control of the telephone coil 37, and the telephone coil 37 itself, are modified such that, simultaneously with the fields leading to acoustic signals, electromagnetic fields are also emitted that are received with the aid of the coil structure 29 in the hearing aid device, and can be transduced back into acoustic signals in the loudspeaker 23 of the hearing aid device 1 by a signal processor 25 taking into account the hearing loss. Additionally, for example, the telephone coil 37 can be controlled by radio-frequency signals that comprise the acoustic data in modulated form. The modulated radio-frequency signals are then, for example, received by an integrated transponder in the hearing aid device 1. In addition to the use of the telephone, the transmission of audio data is an area of interest here. Music signals or radio signals emitted from play-back devices or radios can thereby be transmitted by means of a radio-frequency signal to the hearing aid device 1, received there by a coil structure 29 integrated into a hearing aid device chip or a transponder integrated into a hearing aid device chip, and transduced into acoustic signals by means of a hearing aid device signal processor.

Although other modifications and changes may be suggested by those skilled in the art, it is the intention of the inventors to embody within the patent warranted hereon all changes and modifications as reasonably and properly come within the scope of their contribution to the art.

We claim:

1. An improved hearing aid device, the improvement comprising:
a chip and with a coil for wireless transmission of electromagnetic signals between the hearing aid device and an external transmission and/or receiving unit, said coil being integrated into said chip in a form of a coil structure.

2. A hearing aid device according to claim 1, wherein said coil is an antenna of a transponder.

3. A hearing aid device according to claim 1, further comprising:
a programmable signal processing unit in the hearing aid device.

4. A hearing aid device according to claim 1, further comprising:
a programmable signal processing unit of the hearing aid device connected to said coil.

5. A hearing aid device according to claim 1, wherein said external transmission and/or receiving unit includes a coil formed of an electrical conductor.

6. A hearing aid device according to claim 3, further comprising:
a programming device connected to said external transmission and/or receiving unit for programming said signal processing unit.

7. A hearing aid device according to claim 1, further comprising:
an energy supply system of the hearing aid device that supplies at least some energy for a programming procedure of the hearing aid device, said coil being a part of said energy supply system.

8. A hearing aid device according to claim 2, further comprising:
an energy supply system of the hearing aid device that supplies at least some energy for a programming procedure of the hearing aid device, said transponder being part of said energy supply system.

9. A hearing aid device according to claim 1, wherein said coil structure is a spiral.

10. A hearing aid device according to claim 1, wherein said coil structure runs within a coating level of said chip.

11. A hearing aid device according to claim 1, wherein said coil structure runs within a plurality of coating levels of said chip.

12. A hearing aid device according to claim 1, further comprising:
a device for transmitting acoustic signals that include said external transmission and/or receiving unit as a part, electromagnetic fields from the external transmission and/or receiving unit being emitted and received by the coil structure.

13. A hearing aid device and system, comprising:
a housing adapted to direct sound into an ear of a user;
a microphone to detect ambient sounds;
a speaker in said housing;
a battery in said housing;
a chip substrate in said housing and having a circuit formed thereon, said circuit including a signal processor connected to said microphone;
a coil integrated on said chip substrate and connected to said circuit; and
an external transmission/reception apparatus operable to wirelessly communicate with said coil in said housing.

14. A hearing aid device and system as claimed in claim 13, wherein said coil is formed in a single coating layer on said chip substrate.

15. A hearing aid device and system as claimed in claim 13, wherein said coil is formed in multiple layers on said chip substrate to form a three dimensional structure.

16. A hearing aid device and system as claimed in claim 13, wherein said signal processor is programmable, and wherein said coil receives programming signals from said external transmission/reception apparatus for programming said signal processor.
